(19) United States
(12) Patent Application Publication
(10) Pub. No.: US 2005/0148440 A1
(43) Pub. Date: Jul. 7, 2005

(54) Run-n-vision

(76) Inventor: Juangi Michael Denton, University Park, IL (US)

Correspondence Address: Juangi M. Denton, 604 Farmview Rd., University Park, IL, 60466, US

(21) Appl. No.: 10/818,825

(22) Filed: Apr. 6, 2004

Related U.S. Application Data
(60) Provisional application No. 60/534,280, filed on Jan. 5, 2004.

(51) Int. Cl. G11B 21/08; A63B 22/02

(52) U.S. Cl. 482/54

(57) ABSTRACT

A run n vision in which is a portable digital video disc (dvd) player in a holder with supports thats mounted as (1), A mounting of the portable dvd player holder to the treadmill's frame by mounting supports, (2) A mounting of portable dvd player holder on the tracks of a drawer to the underside of the treadmill's console and (3), A mounting of portable dvd player holder by poles (metal) connecting to the underside of the treadmill's console.

### FIELD OF THE INVENTION

This invention relates generally to the mounting of a portable DVD player holder to a treadmill and particularly to hold the portable DVD player out in front of a person while running/walking on the treadmill with a frame/console attaching mount.

### SUMMARY OF INVENTION

This objective of the invention is to provide a moving vision (portable dvd player) of entertainment to people on the treadmill while they work out or exercise. The objective of the invention is to take the boredom out of the exercising while on the treadmill. The objective of this invention is to put the person's mind on the movie rather than the exercise. The objective of this invention is to enable a person to lose more weight without focusing on it by staying on the treadmill longer and burning more calories in the process. The objective of this invention is to enable a runner/walker to build their endurance and increase their mileage by exercising or trying to exercise the entire length of their favorite movie they put in to exercise with.

### BACKGROUND AND SUMMARY OF THE INVENTION

This invention relates to a portable DVD player in a holder that's attached to supporting mounts that are mounted to either the underside of the treadmill's console or its frame. There are monitoring displays on the treadmills' console that shows things like calories, miles per hour, time etc. but these are only information displays. They don't take your mind off of your work out on the treadmill. What ever you are looking at for example, a magazine on the treadmill's console or the wall in front and around you, after a while it gets boring, and as a result it makes you less interested in your work out and often times people stop exercising on the treadmill altogether. This invention (when portable DVD player is sitting in the holder) allows you to bring your favorite movie with you so you can watch it while you work out on the treadmill. Simply put the DVD in the portable DVD player and watch it while you work out. This will not only take your mind off of your work out, but it will entertain you as well. You can set goals off of how long you worked out in the length of time of the movie. The portable DVD player holders are mounted three different ways. This will allow manufactures to choose the one they like best. The portable DVD player holder can hold from 5″ wide to 10″ wide or greater. This invention will help people to loose weight without noticing, because movies are at least 70 min. long. Even if they walk and not finish the first movie out, they can set a goal to walk or run their favorite movie out to the end. This invention allows the portable DVD player to be positioned according to your height, right out in front of you for perfect viewing. The mounts can be adjusted up and down and closer or farther away from you. This invention allows entertainment to be apart of your work out. This invention brings a vision to your walk or run that you'll love. This invention when the portable DVD player is sitting in its holder is named “The Run N Vision”.

### DETAILED DESCRIPTION OF THE INVENTION

This is how the portable DVD player in the holder is mounted to its supporters and to the frame of the treadmill or underside of the treadmill's console. In FIG. 1 the portable DVD player holder (4) is attached to the support bars (3) and (6). Number (3) is a little larger in diameter, so the other support bar (6) can fit into it, this will allow the bars to adjust to the various widths of the treadmills. The bars (2) that are attached to the frame (1) of the treadmill are connected to bars (3) and (6) with a washer, nut and bolt of some sort. This will allow for a height adjustment for the various heights of people. The portable DVD player (5) that's sitting in the plastic holder (4) can be made to accommodate any size portable DVD player 5″ to 10″ in width or greater. The portable DVD player can be strapped into the holder or velcroed to the inside bottom so it can't move around. The bar (2) can be attached to the frames (1) by either holes being pre-drilled through them so you can put bolts through the frame (1) and through them or maybe a metal band can be used to secure the bars (2) to the treadmill's frame (1). The portable DVD player holder's (4) underside or bottom can have some sort of plastic attachment to secure bars (3 and 6) to it. This will also allow for an adjustment of the portable DVD player holder (4) for the best position to eliminate glare etc. for the individual's viewing. The bars (2) attaching end to the treadmill's frame (1) can be shaped to fit whatever shape of the treadmills' frame happens to be. Some treadmills have round support frames, some have various angles etc. so for whatever shape the manufacturer can combine the shape with the treadmill's frame for a perfect fit. The portable DVD player holder (4) can be made with various materials such as metal, wood, plastic etc. The portable DVD player (5) can be either set into the holder (4) or slid inside of it. This portable DVD player in holder (4) and bar supports (3 and 6) creates the Run N Vision. In FIG. 2 is the drawer to console mount. This mount (7) is either a wooden or plastic drawer that's attached to the underside of the treadmill's console (8). This drawer size will be made to accommodate from either a 5″ portable DVD player to a 10″ portable DVD player or a little wider. The portable DVD player (5) is placed inside of the drawer with its flip down lid and the portable DVD player maybe attached to the drawer's inside bottom by velcro. The drawer will be lifted to a certain angle and then pushed down into the drawer'housing on tracks. Also you can design or attach a motor to the drawer, so the drawer can electronically be pushed out of its housing and come down parallel to the floor. At this time all is needed is to flip open the portable DVD player and turn it on. In FIG. 3 is the portable DVD player holder (4) mounted to support poles (10) by latches (folding) (9). The support poles (10) will allow for the adjustment for the height of the individual person. The pole (9) supports or holder (13) can be made as a part of the underside of the console material. There are metal pins (12) of some sort that will be placed through the holes (11) in poles (9) for height adjustment. The latches (9) will allow the portable DVD player holder (4) to be locked into position. This style of the portable DVD player holder (4) can have a velcored bottom to hold the portable DVD player (5) and a plastic cover that opens from one side to allow for opening of portable DVD player disk placement. This portable DVD player (5) when placed in the portable DVD player holder (4) to pole support (9), to the underside of the treadmill's console (8) is the creation of the Run N Vision. The portable DVD player holder is attached to the support poles (10) by some type of rivet pins (15). This will allow for the portable DVD player (4) to be able to swing in and out. This invention (The RUN N Vision) in FIG. 0 looks like the actual view when attached to the treadmill.

### BRIEF DESCRIPTION OF DRAWING

FIG. 1 is a drawing showing the portable dvd player in a holder supported by metal supports mounted to the treadmill's frame in accordance with this Invention.

FIG. 2 is a drawing showing the portable dvd player in a drawer mounted to the underside of the treadmill's console in accordance with this invention.

FIG. 3 is a drawing showing the portable dvd player in holder supported by poles mounted to the underside of the treadmill's console in accordance with this invention.

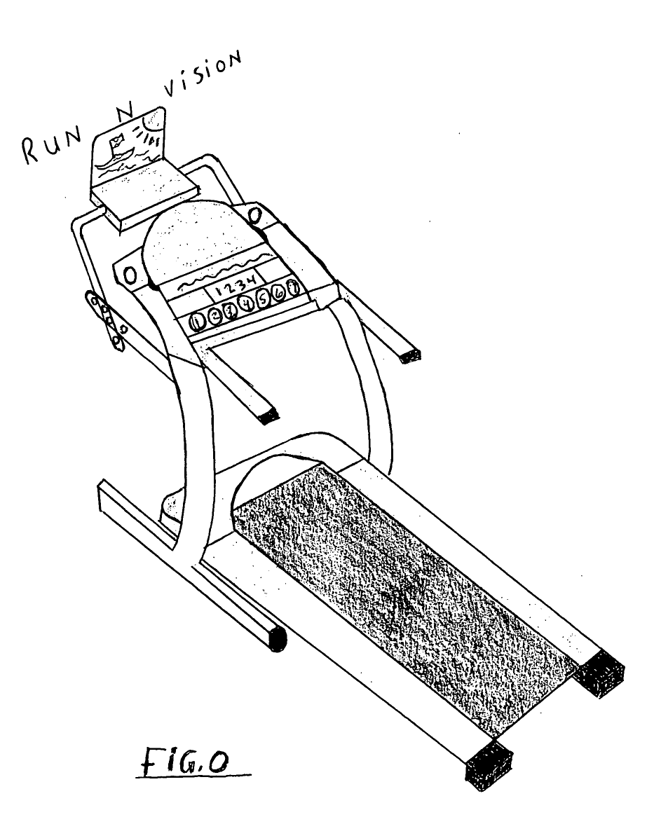

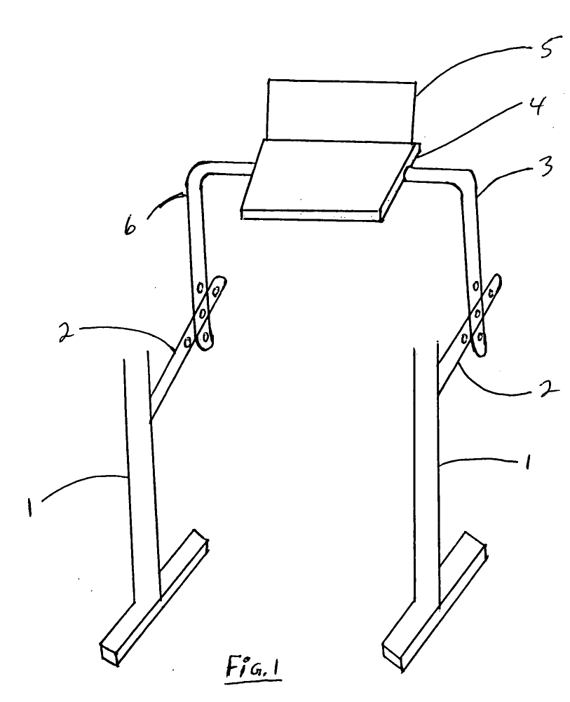

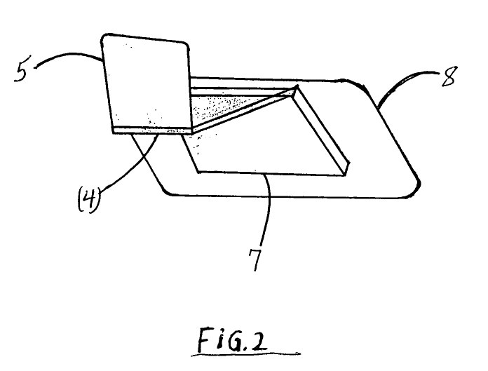

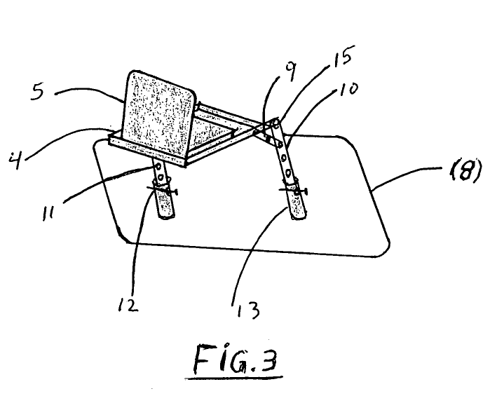

1) A portable DVD player in a holder with supports mounted to a treadmill (named the Run N Vision) by a plurality of various mounts and to thereupon provide a mounting for each of such specified conditions, comprising a mounting means to mount the portable DVD player in holder to said treadmill's frame, said mounting means to mount the existence of such first condition, second mounting means to mount the portable DVD player in a drawer to the underside of said treadmill's console, said mounting means to mount existence of such second condition, third mounting means to mount the portable DVD player in a holder supported by poles mounted to the underside of said treadmill's console, said mounting means to mount the existence of the third condition.

2) A portable DVD player holder as set forth in claim 1, wherein said portable DVD player in holder includes third mounting means the portable DVD player in a holder supported by poles, mounted to the underside of said treadmill's console, said mounting means to mount the existence of the third condition at said treadmill's console.

3) A portable DVD in holder as set forth in claim 2, wherein said portable DVD player in holder includes said third condition, whereupon said third mounting means to mount portable DVD holder to supports of poles to said underside of treadmill's console. These support poles mounted to said underside of treadmill's console are in holders to support adjustment of said third mounting condition.

4) A portable DVD player in holder as set forth in claim 1, wherein said first mounting means of said first condition to mount to said treadmill's frame.

5) A portable DVD player in holder as set forth in claim 4, wherein said first mounting means the said portable DVD player in holder's height is adjusted by the said mounting poles to said treadmill's frame and also the width of said treadmill is adjusted by said mounting poles of said first condition.

6) A portable DVD player in holder as set forth in claim 5, wherein said various treadmill's width is accommodated by the mounting poles of said first mounting means, by sliding smaller poles into larger pole for the adjustment to fit said varying widths of treadmills.

7) A portable DVD player in holder as set forth in claim 6, wherein said mounting poles are attached to underside of said portable DVD player holder whether wooden or plastic, allows for said portable DVD player holder to twist for said portable DVD player screen adjustment for viewing by people exercising on said treadmill.

8) A portable DVD player in holder as set forth in claim 1, wherein said second mounting means of said second condition.

9) A portable DVD player in holder asset forth in claim 8, wherein said second mounting means the portable DVD player holder is a drawer within a housing mounted to said underside of said treadmill's console, where thereupon the drawer comes out and is latched parallel to the floor so portable DVD player can be viewed.

10) A portable DVD player in holder asset forth in claim 9, wherein said second mounting means of said second condition can also have a motor controlling said drawer of second mounting means, to electrically control said drawer of said second mounting means.

11) A portable DVD player in holder asset forth in claim 1, wherein said third mounting means of said third condition.

12) A portable DVD player in holder as set forth in claim 11, wherein said, third mounting means portable DVD player holder is hinged to poles with holes for adjustments of height of said third condition, whereupon the support poles are seated in attaching holders to said treadmill console underside.

13) A portable DVD player in holder as set forth in claim 12, wherein said, third mounting means uses a latched hinge on said portable DVD player holder to said portable DVD player holder support bars to hold said portable DVD player in line of sight with person on said treadmill.
